(19) United States
(12) Patent Application Publication
(10) Pub. No.: US 2012/0279133 A1
(43) Pub. Date: Nov. 8, 2012

(54) HINGED LATCH

(75) Inventor: Peter Vullings, Palmerston North (NZ)

(73) Assignee: Empire Technology Development LLC, Wilmington, DE (US)

(21) Appl. No.: 13/254,146

(22) PCT Filed: May 4, 2011
(86) PCT No.: PCT/US11/35205

§ 371 Date: Aug. 31, 2011

(51) Int. Cl. E05D 11/10; E06B 3/40; E05F 1/12

(52) U.S. Cl. 49/385; 16/319; 16/297; 49/506

(57) ABSTRACT

Described herein is a hinge and latch system that can be employed as a hinge, a latch, or both a hinge and a latch.

### TECHNICAL FIELD

The relevant technology generally relates to opening and closing type devices.

### BACKGROUND

A variety of hinge, latch, and hinge and latch devices exist that can be used to allow for the opening and/or closing of doors and other pivoting and/or latch type devices. Some such devices only allow for the door or other pivoting device to only be opened in a single direction. Other devices allow for the door or other pivoting device to be operated in two different directions.

### SUMMARY

In some embodiments, an apparatus is provided that includes a pivot member having a first protrusion, a retaining member coupled to the first protrusion, and a second protrusion coupled to the retaining member. The apparatus can include a first seat having a first indentation, wherein the first indentation is configured to receive the first protrusion when the first protrusion and the first indentation are aligned, but not when the first protrusion and the first indentation are not aligned. The apparatus can include a housing having a proximal opening through which the second protrusion can extend, wherein the housing is configured to retain the retaining member while allowing movement of the pivot member from an extended position, in which the pivot member is capable of pivoting, to a retracted position, wherein the first seat is positioned so that a surface of the first seat blocks the pivot member from moving from the extended position to the retracted position unless the first projection is aligned with the first indentation, and a second seat that includes a second indentation, wherein the second indentation is configured to receive the second protrusion, and wherein when the second indentation receives the second protrusion, the second indentation and second protrusion are unable to rotate with respect to one another.

In some embodiments a pivotable structure is provided that includes a pivot member having a first rectangular protrusion having a first corner and a second corner, a retaining member including a first surface and an oppositely positioned second surface, wherein the first protrusion is attached to and extends substantially perpendicularly outward from the first surface a second protrusion having a third corner and a fourth corner. In some embodiments, the second protrusion is attached to and extends substantially perpendicularly outward from the second surface, wherein the third corner includes an angle that is greater than ninety degrees, and wherein the fourth corner includes an angle that is greater than ninety degrees. In some embodiments there is a seat that includes an indentation, wherein the indentation is configured to receive the first rectangular protrusion when the first rectangular protrusion is aligned such that a surface of the first rectangular protrusion is substantially parallel with a surface of a wall of the indentation, and a housing having a spring, and a proximal opening that is too small to allow the retaining member to fit through, wherein the pivot member is positioned such that the second protrusion extends through the proximal opening of the housing while the first protrusion remains within the housing, and wherein the housing allows movement of the retaining member to a first position close to the proximal opening, in which the pivot member is capable of pivoting, to a second position that is more distal to the proximal opening, and wherein the spring is positioned to urge the retaining member to the first position.

In some embodiments, an apparatus is provided that includes a frame, a door configured to fit within the frame, and a set of hinged-latches, pivotably associating the door to the frame. A hinged-latch can include any of the hinged latches disclosed herein, including, for example, one with a pivot member having a first protrusion, a retaining member coupled to the first protrusion, and a second protrusion coupled to the retaining member, a first seat having a first indentation, wherein the first indentation is configured to receive the first protrusion when the first protrusion and the first indentation are aligned, but not when the first protrusion and the first indentation are not aligned, a housing having a proximal opening through which the second protrusion can extend, wherein the housing is configured to retain the retaining member while allowing movement of the pivot member from an extended position, in which the pivot member is capable of pivoting, to a retracted position, wherein the first seat is positioned so that a surface of the first seat blocks the pivot member from moving from the extended position to the retracted position unless the first projection is aligned with the first indentation; and a second seat that includes a second indentation, wherein the second indentation is configured to receive the second protrusion. In some embodiments, when the second indentation receives the second protrusion, the second indentation and second protrusion are unable to rotate with respect to one another.

In some embodiments, a method of operating a dual pivot point door is provided. The method can include providing a dual pivot point door having a frame, a door configured to fit within the frame, and a set of hinged-latches, pivotably associating the door to the frame. The hinged-latch can include a pivot member having a first protrusion, a retaining member coupled to the first protrusion, and a second protrusion coupled to the retaining member. It can further include a first seat having a first indentation, wherein the first indentation is configured to receive the first protrusion when the first protrusion and the first indentation are aligned, but not when the first protrusion and the first indentation are not aligned, and a housing having a proximal opening through which the second protrusion can extend. The housing can be configured to retain the retaining member while allowing movement of the pivot member from an extended position, in which the pivot member is capable of pivoting, to a retracted position, wherein the first seat is positioned so that a surface of the first seat blocks the pivot member from moving from the extended position to the retracted position unless the first projection is aligned with the first indentation. It can further include a second seat having a second indentation, wherein the second indentation is configured to receive the second protrusion. In some embodiments, when the second indentation receives the second protrusion, the second indentation and second protrusion are unable to rotate with respect to one another. In some embodiments, the door includes a front surface, a first pivot line extending from the first hinged-latch though the door to the second hinged-latch, and a second pivot line extending from the third hinged-latch though the door to the fourth hinged-latch. In some embodiments, the method further includes applying a first opening force perpendicularly to the front surface of the door at a position closer to the first pivot line than the second pivot line, such that the first and second hinged-latches operate as latches, and such that the third and fourth hinged-latches operate as hinges and the door pivots about the second pivot line.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a top down depiction of some embodiments of a pivot member for a hinged-latch.

FIG. 2 is a side view depiction of some embodiments of a pivot member for a hinged-latch.

FIG. 3 is a top down depiction of some embodiments of a housing member for a hinged-latch.

FIG. 4 is a side view depiction of some embodiments of a housing member for a hinged-latch.

FIG. 5 is a top down depiction of some embodiments of a first seat for a hinged-latch.

FIG. 6 is side view depiction of some embodiments of a first seat for a hinged-latch.

FIG. 7 is a top down depiction of some embodiments of a second seat for a hinged-latch.

FIG. 8 is a side view depiction of some embodiments of a second seat for a hinged-latch.

FIG. 9 is a side view depiction of some embodiments of a hinged-latch.

FIG. 10 is a front view depiction of some embodiments of a framed door employing four hinged-latches.

FIG. 11A is a top down depiction of some embodiments of a hinged-latch within a door, when the door is in the closed position.

FIG. 11B is a top down depiction of some embodiments of a hinged-latch within a door, when the door is ajar.

FIG. 12A is a side view depiction of some embodiments of parts of a hinged-latch.

FIG. 12B is a perspective view depiction of some embodiments of a seat.

FIG. 12C is a perspective view depiction of some embodiments of pivot member.

FIG. 13 is a depiction of some embodiments of first indentations and first protrusions.

FIG. 14 is a depiction of some embodiments of second protrusions and second indentations.

FIG. 15 is a depiction of some embodiments employing a tension spring arrangement.

### DETAILED DESCRIPTION

Frequently, doors (and other pivoting structures) are designed with a hinge at one side which allows them to swing open from that side. This can be described as the ‘handedness’ of the door (e.g., right-handed or left-handed). Home design, work space, and living space design (for example) can be compromised because this limited handedness of the open door can hinder the operation of other doors or equipment.

Provided herein are various hinged-latch devices that can be employed as a hinge and/or pivot system and/or a latch. In some embodiments, the device can serve as both the hinge and/or the latch unit. In some embodiments, the hinged-latch can be installed on all four corners of a door, and can allow the door to then swing open from either side and latch from the appropriate opposing side.

In some embodiments, the hinged-latch involves a housing that retains a pivot member. The pivot member can move from an extended position, in which the pivot member can pivot about its axis, to a retracted position. The pivot member is biased to the extended position; however, a sufficient amount of force applied to the pivot member will force it into its retracted position. In some embodiments, the pivot member is located in a frame. The pivot member has a protrusion, and in the extended position, the protrusion of the pivot member can engage an indentation (which can be located in the door) that is configured to receive the protrusion and thereby create the pivot point, allowing the structure to operate as the hinge. When an adequate separating force is applied to the structure, the protrusion will separate from the indentation, effectively, operating the structure as the released latch.

In some embodiments, a force applied pivotably to a hinged-latch allows the hinged-latch to act as a hinge, while a force applied perpendicularly to the hinged-latch allows the pivot member to become disengaged from the seat and allows the hinged-latch to operate as a latch.

The following description outlines the basic parts of various embodiments of the hinged-latch in more detail and with respect to the figures, it then describes various specific variations and embodiments for various parts of the device and methods.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

### Hinged-Latch

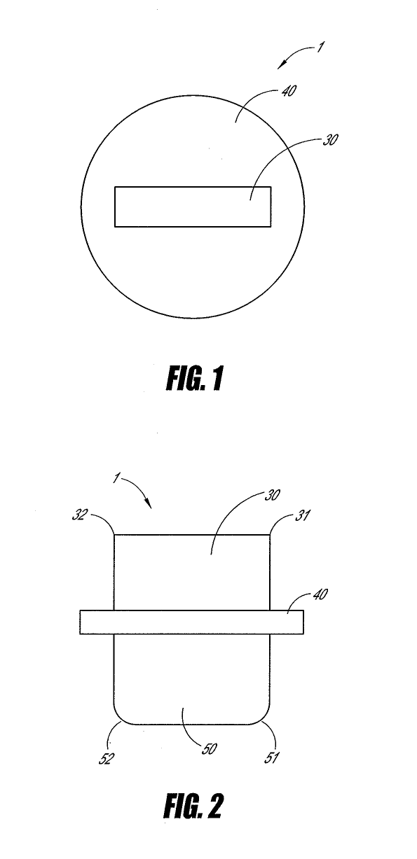

Some embodiments of the hinged-latch are depicted in FIGS. 1-9.

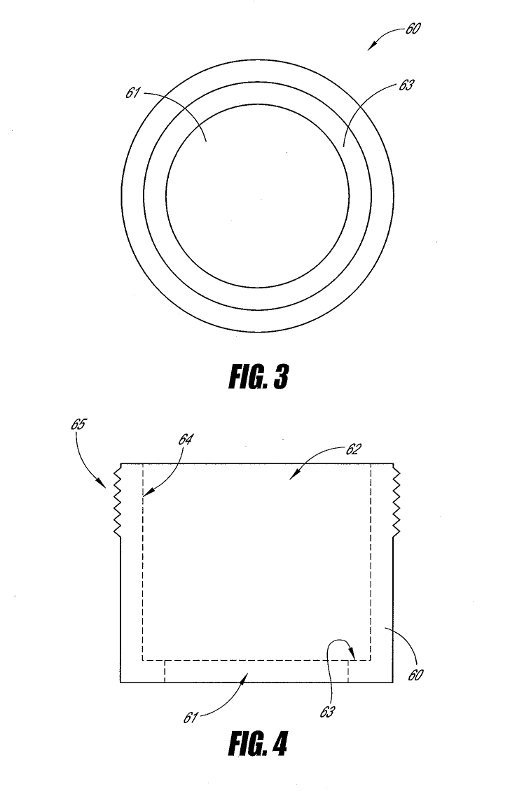

FIG. 1 depicts a view from above of a pivot member 1, including a first protrusion 30 and a retaining member 40. FIG. 2 depicts a side view of the pivot member 1, including the first protrusion 30, which is attached to the retaining member 40, which is in turn attached to a second protrusion 50.

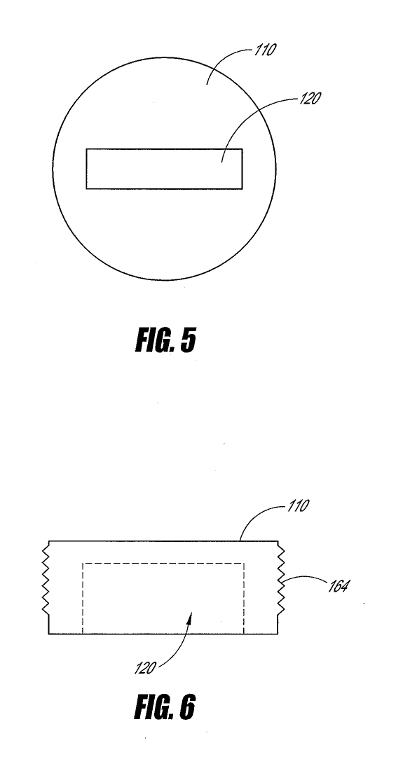

FIG. 3 is a top down view depicting some embodiments of a housing 60, which has a proximal opening 61, and optionally an inner lip 63. FIG. 4 is a side view of the housing 60, depicting both the proximal opening 61 and a distal opening 62. In some embodiments, the housing can include external threads 65, for ease of insertion into a door or frame, and internal threads 64, to allow additional structures to be added to the housing.

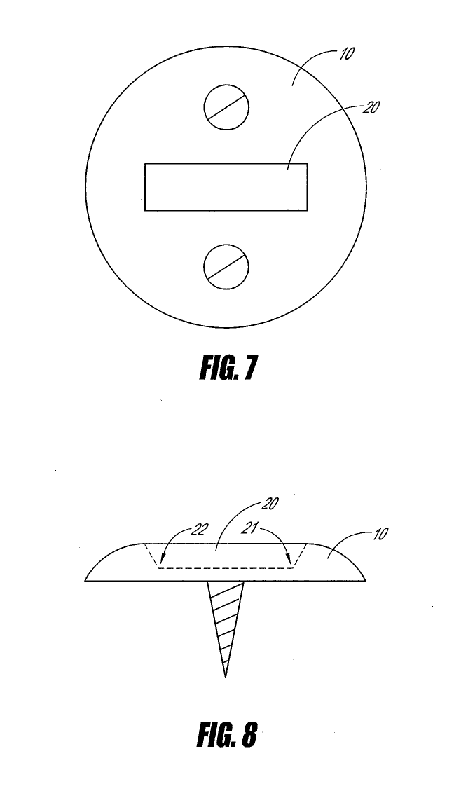

FIG. 5 is a bottom up view of some embodiments of a first seat 110, depicting a first indentation 120. In some embodiments, the first seat is optional. In some such embodiments, once the door starts opening it is possible to then also start opening it from the other side (thus completely removing the door). FIG. 6 is a side view of the first seat 110, depicting the first indentation 120 and optional threads 164.

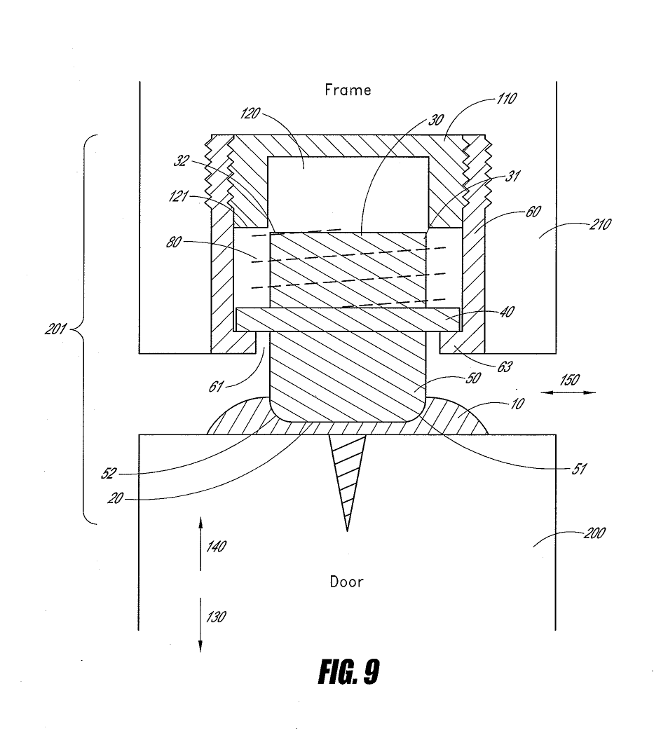

FIG. 7 depicts a view from above of a second seat 10 of the hinged-latch, which includes a second indentation 20. FIG. 8 depicts a side view of the second seat 10. In some embodiments, the second indentation 20 looks similar to the head of a flat-head screw. In some embodiments, the second seat 10 includes a shallow dome. In some embodiments, the second indentation 20 is a slot with sloping sides. In some embodiments, the center of the second seat when looking down on it (as in FIG. 7) is the center of rotation of the hinge (pivot point, pivot line, axis of rotation). In some embodiments, the second seat forms the seat for the pivot member when the device functions as a hinge.

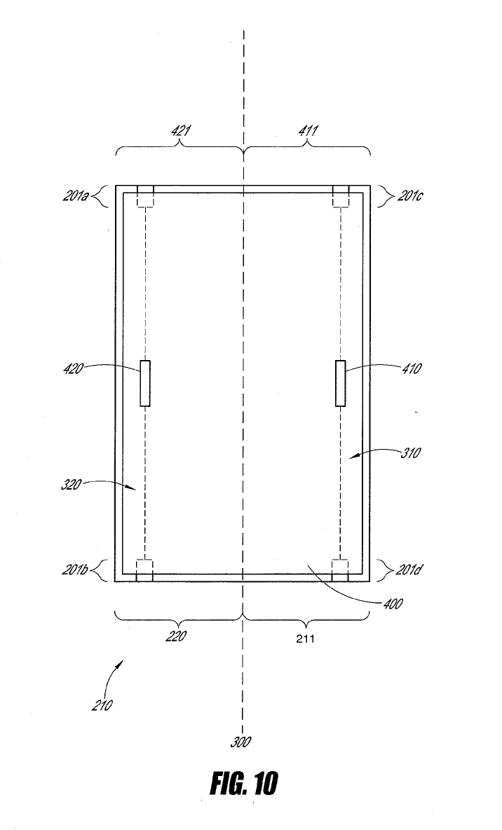

FIG. 9 depicts some embodiments for how the pivot member 1 can interact with the first seat 110, the second seat 10, and the housing 60, when associated for a latch and/or hinge. As depicted in FIG. 9, some embodiments of the hinged-latch involve the pivot member 1 being positioned within the housing 60, such that the second protrusion 50 extends through the proximal opening 61 and can make contact with the second seat 10 and engage the second indentation 20. As shown in FIG. 9, the hinged-latch can include a spring 80, which can urge the pivot member against the second seat 10 and serve to stabilize the association of the pivot member 1 with the second seat 20. The retaining member 40 keeps the pivot member associated with the housing 60, while allowing the pivot member to still pivot. As shown in FIG. 9, the first protrusion 30 is not engaged with the first indentation 120, allowing the pivot member to pivot in regard to the housing. However, when a sufficient force administered in a direction that is perpendicular to a line passing through the pivot member 1 and the second seat 10 (e.g., in direction 150) is applied, the second protrusion 50 can be unseated from the second indentation 20 (resulting in separation of the hinged-latch), which moves the first protrusion 30 into the first indentation 120, whereupon, in some embodiments, the pivot member 1 is restrained in its ability to pivot.

In some embodiments, described in more detail below, the first seat 110 and the first indentation 120 serve as a safety and/or security feature for the device. For example, as the first protrusion moves from an extended position 130 (shown in FIG. 9) to a retracted position 140 when the hinged-latch is separated (meaning when the second protrusion 50 separates from the second seat 10), having a first seat 110 and a first indentation 120 allows for a finite number of orientations in which the first protrusion 30 can actually enter the retracted position 140. For example, in some embodiments, the arrangement in FIG. 9 allows the pivot member 1 (and the first protrusion 30) to move into the retracted position 140, because the first protrusion 30 can fully slide into the first indentation 120, allowing for the second protrusion 50 to come clear of the second indentation 20. However, if the orientation of the first protrusion 30 and the first indention 120 are not aligned so as they can engage one another, then the bottom surface 121 of the first seat will block the first protrusion's movement into the retracted position 140. The advantages of such an arrangement are discussed in more detail below.

As used herein, when a force is applied in the direction 150 to a first part of the hinged-latch (e.g., housing and pivot member, or a structure that is affixed by the housing and pivot member) but not the second part of the hinged-latch (e.g., second seat, or a structure that is affixed by the second seat), and the force separates the hinged-latch into two parts, it is generally denoted as a “separating force.” Similarly, when an opposite force is applied to two such separate parts and it combines the two separate parts into, for example, the arrangement in FIG. 9, such a force is denoted as a “closing” or “combining force.”

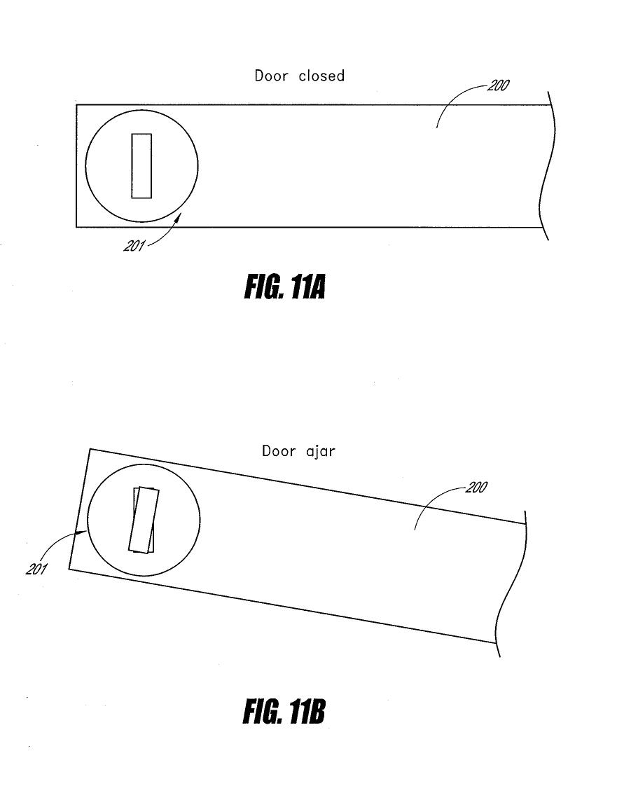

FIG. 10 depicts some embodiments employing four hinged-latches 201a, 201b, 201c, and 201d on a door 400, including a first handle 420 and a second handle 410. Line 320 displays a pivot point or line which extends through a top side of the door to the bottom side and goes from the first hinged-latch 201a to the second hinged-latch 201b. When hinged-latches 201a and 201b function as hinges, pivot line 320 shows where the door will pivot about. In such a mode, hinged-latches 201c and 201d function as latches and allow separation of the door from the frame on the opposite side of the door. In contrast, when hinged-latches 201c and 201d function as hinges, pivot line 310, which extends from a top to an opposing side of the door, through both hinged-latches 201c and 201d shows where the door pivots about. In such a mode, hinged-latches 201a and 201c function as latches and allow separation of the door from the frame on the opposite side of the door. When the door is to pivot about the first pivot line 320, the user applies a force substantially perpendicular to the plane of the door (e.g., out of the plane of the figure) at, for example, handle 410. When the door is to pivot about the second pivot line 310, the user applies a force substantially perpendicular to the plane of the door (e.g., out of the plane of the figure) at handle 420.

In some embodiments, the handles can be situated along the pivot line and be vertically centered. In some embodiments, the handles are situated along the pivot line and are not vertically centered. In some embodiments, the handles are not situated along the pivot line and are vertically centered. In some embodiments, the handles are not situated along the pivot line and are not vertically centered. In some embodiments, a handle can be placed anywhere, as long as the handle is horizontally closer to one set of latches than the other. In some embodiments, the further the handle is horizontally from the opposite latches, the more efficient it will be. Likewise, vertical placement of the handle can be more efficient if centered, but such placement is not a requirement.

In some embodiments, enough force is used to push the pivot member 1 up into the retracted position 140 (against the force of the spring 80) freeing it from the second seat 10. The amount of force required for this will depend upon the particular application employed. In some embodiments for many standard home applications, the amount of force employed can be about the same, slightly more, or slightly less than the amount of force (a short, sharp tug) required to open latched doors, especially those with spring, gripped or magnetic latch that can employ a sharp opening force to disengage them.

In some embodiments, the amount of force required to open or close a door involving a hinged-latch can be adjusted. In some embodiments, the force required to open the door is controlled by the depth of the indentation 20 in the second seat 10, and/or the properties of the corners of the protrusion and the indentation, and/or the stiffness and/or level of compression of the spring 80. In some embodiments, these aspects are set according to the specific door or application, and can take into account the weight of the door and how much force it will be subjected to when not in use (e.g. external noise, such as wind and sources of vibrations).

In some embodiments, the door can be readily installed and/or removed. In some embodiments the door can be installed by lining up the second seats 10 with the second protrusions 50 of all four hinged-latches (201a, 201b, 201c, and 201d) and pressing both sides of the door 400 into the frame 210 at once. The door 400 can likewise be removed from the frame 210 by pulling both sides of the door at once. In some embodiments, this is unlikely to occur in normal operation, and may involve more force for larger doors or applications.

In some embodiments, as shown in FIG. 10, the second seat is attached to the frame 210. In other embodiments, the second seat is instead attached to the door 400 (and the housing 60, pivot member 1, and first seat 110 are attached to the frame 210). As shown in FIG. 10, the seats can be attached to all four corners of the frame, positioned opposite of the top of the door and the bottom of the door.

As shown in FIG. 9, in some embodiments, when acting as a latch, the second protrusion 50 sits in the second indentation 20 and the pressure of the spring 80 keeps the second protrusion in the second indentation 20.

In some embodiments, when acting as a hinge, the rotation of the door/seat causes the pivot member 1 to also rotate. The pivot member 1 is free to rotate with respect to and/or within the housing 60. Under such operation, the pivot member 1 avoids obstructing contact with the second seat 110.

In some embodiments, the housing 60 forms an enclosure for at least a part of the pivot member 1 and the spring 80. In some embodiments, the first seat 110 can be screwed into the end of the housing 60 and holds the spring 80 and pivot member in place. In some embodiments, the housing 60 is also threaded around the outside, allowing it to be inserted/screwed directly into a hole drilled in the frame 210 or into the door 400.

In some embodiments, when acting as a latch, the pivot member 1 is able to be pushed into the housing 60 into the retracted position 140. The first indentation 120 receives the first protrusion 30 when the first indentation 120 is aligned with the first protrusion 30, which occurs when the door is closed. In some embodiments, this happens when the operator tugs the door to open it from a closed position.

In some embodiments, when acting as a hinge, the pivot member 60 is able to freely rotate with respect to the housing 60 and does not make significant contact with the first seat 110. In some embodiments, the weight of the door rests on the lower two hinged-latches 201b and 201d (in FIG. 10), in some such embodiments, the spring 80 in these hinged-latches can be sufficiently stiff to ensure that the first protrusion 30 does not engage the first indentation 120.

In some embodiments, a method of operating a dual pivot point door (and example of which is shown in FIG. 10) is provided. In some embodiments, the method can be applied to any of the hinged-latch arrangements described herein. In some embodiments, the method includes providing a dual pivot point door that includes providing a frame, a door configured to fit within the frame, and a set of hinged-latches, pivotably associating the door to the frame. The hinged-latch can be any embodiments described herein. In some embodiments, the hinged-latch can include a pivot member having a first protrusion, a retaining member coupled to the first protrusion, and a second protrusion coupled to the retaining member. It can further include a first seat having a first indentation, wherein the first indentation is configured to receive the first protrusion when the first protrusion and the first indentation are aligned, but not when the first protrusion and the first indentation are not aligned, a housing having a proximal opening through which the second protrusion can extend. The housing can be configured to retain the retaining member while allowing movement of the pivot member from an extended position, in which the pivot member is capable of pivoting, to a retracted position. In some embodiments, the first seat is positioned and/or configured so that a surface of the first seat blocks the pivot member from moving from the extended position to the retracted position unless the first projection is aligned with the first indentation. It can, optionally, further include a second seat having a second indentation, wherein the second indentation is configured to receive the second protrusion, wherein when the second indentation receives the second protrusion, the second indentation and second protrusion are unable to rotate with respect to one another. In some embodiments, the door includes a front surface, a first pivot line extending from the first hinged-latch though the door to the second hinged-latch, and a second pivot line extending from the third hinged-latch though the door to the fourth hinged-latch. In some embodiments, the method further includes applying a first opening force perpendicularly to the front surface of the door at a position closer to the first pivot line than the second pivot line, such that the first and second hinged-latches operate as latches, and such that the third and fourth hinged-latches operate as hinges and the door pivots about the second pivot line.

In some embodiments, the door can include a front surface, a first pivot line 320 extending from the first hinged-latch 210a though the door to the second hinged-latch 201b, and a second pivot line 310 extending from the third hinged-latch 201c though the door to the fourth hinged-latch 201d. The method can also include applying a first opening force perpendicularly to the front surface of the door (e.g., a separating force) at a position closer to the first pivot line 320 than the second pivot line 310, such that the first and second hinged-latches 201a and 201b operate as latches, and such that the third and fourth hinged-latches 201c and 201d operate as hinges and the door pivots about the second pivot line 310. In some embodiments, the method also includes applying a force opposite in direction to the first opening force (e.g., a closing force), to close the door. The method can also include applying a second opening force perpendicularly to the front surface of the door at a position closer to the second pivot line 310 than the first pivot line 320, such that the first and second hinged-latches 201a and 201b operate as hinges, and such that the third and fourth hinged-latches 201c and 201d operate as latches so that the door pivots about the first pivot line 320.

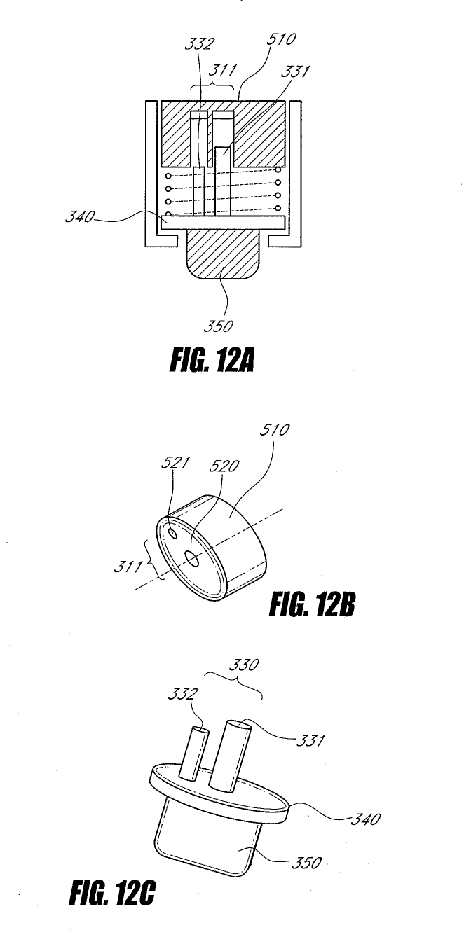

In some embodiments, the hinged-latch can include and/or provide a safety arrangement. In some embodiments, the configuration is such that it stops a door coming off when the door has already started to be opened. In some embodiments, if the door is closed, the first protrusion 30 and the first indentation 120 are aligned (shown in FIG. 11A). However, when the door is slightly ajar, the first protrusion 30 of the pivot member 1 acting in its capacity as a hinge (rather than a latch) has rotated and will no longer align with the first indentation 120 (shown in FIG. 11B). In such a configuration, the operator will not be able to separate the hinged-latch (disengage the second protrusion 50 from the second indentation 20), as the first protrusion 30 will not be able to move up into the retracted position 140. Because of this, the second protrusion 50 will remain engaged with the second seat 10 in the second indentation 20.

As will be appreciated by one of skill in the art, in light of the present disclosure, the preciseness of the fit of the first protrusion 30 with the first indentation 120 can control how many degrees the door will open before the hinged-latch will no longer disengage or separate into two parts. In some embodiments, the configuration allows for the pivot member to enter the retracted position for 0 to 20 degrees. In some embodiments 1-19, more than 0-15, more than 0-10, more than 0-9, more than 0-8, more than 0-7, more than 0-6, more than 0-5, more than 0-4, more than 0-3, more than 0-2, or more than 0-1 degrees of rotation can occur before the first protrusion will be off of alignment enough to prevent the pivot member from entering into the retracted position 140.

### Additional Embodiments and Variations

For the sake of clarity and brevity, the following variations have been provided, with the understanding that these variations are contemplated as being combined and/or applied in any of the embodiments described herein.

In some embodiments, the hinged-latch can be manufactured as four separate parts that can be cast from any suitable material (including plastics, metals, or any combination thereof). In some embodiments, a fifth part includes a short spring. In some embodiments, the spring of any lower hinge (that taking the weight of the door) can be stiffer than those of an upper hinges.

In some embodiments, one or more hinged-latches are employed. In some embodiments, two hinged-latches are employed on any one door. In some embodiments, three hinged-latches are employed on any one door, with two on one side and one on the opposing side. In some embodiments four hinged-latches are employed on each door or item to be supported. In some embodiments, the hinged-latches can be placed on four corners of a door. In some embodiments, the hinged-latches are placed away from the sides of the doors, and closer to the center of the doors. Thus, in some embodiments, the door can pivot about a point that is set more towards the center of the door than the edge of the door. In some embodiments the hinges are positioned in the top end and bottom end of the door, so as to allow the door to be opened to the left or opened to the right. In some embodiments, the hinges are positioned in the left end and right end of the door, so as to allow the door to be opened upwards or downwards.

In some embodiments, the housing 60 houses part of the pivot member 1. In some embodiments, the housing merely allows for restraint of the pivot member. In some embodiments, the housing is within the pivot member, while allowing the pivot member to move into its retracted position 140 and its extended position 130, as well as pivoting. For example, in some embodiments the housing is a post over which the pivot member sits and can move into positions 140 and 130. In some embodiments, the housing 60 simply includes an outer ring, sized so as to allow for retention of the retaining member 40. In some embodiments, the housing is formed from the door 200 or frame 210 itself, and can be a hole in either the door or frame. In some embodiments, the housing 60 includes inner threads 64, outer threads 65, or both inner and outer threads. In some embodiments, the housing is cylindrical or rectangular. In some embodiments, the first seat is detachable from the housing. In some embodiments, the housing is made of, for example, plastic, nylon, rubber, metal, copper, brass, iron, steel bronze, nickel, wood, or any combination thereof. In some embodiments, the first seat is attachable/insertable (and is so configured) into the housing in a variety of ways. In some embodiments, the attachment can be a push fitting, clips, screws, or any other manner of fastening. In some embodiments, the first seat can also be placed against the end of the housing without afixing it.

In some embodiments, the retaining member 40 is a flat plate having a top and bottom or first and second surface. In some embodiments, the retaining member 40 is a structure that will allow the pivot member 1 to stay associated with the housing, while allowing the pivot member 1 to pivot about its center. In some embodiments the retaining member 40 is a circular plate, disk, or ring, wherein the diameter of the object is too large to fit through the proximal opening 61 of the housing 60. In some embodiments, the retaining member 40 is cross shaped or star shaped, so that the ends of the cross or star come into contact with an inner lip 63 of the housing. In some embodiments, the retaining member is made of, for example, plastic, nylon, rubber, metal, copper, brass, iron, steel, bronze, nickel, wood, or any combination thereof.

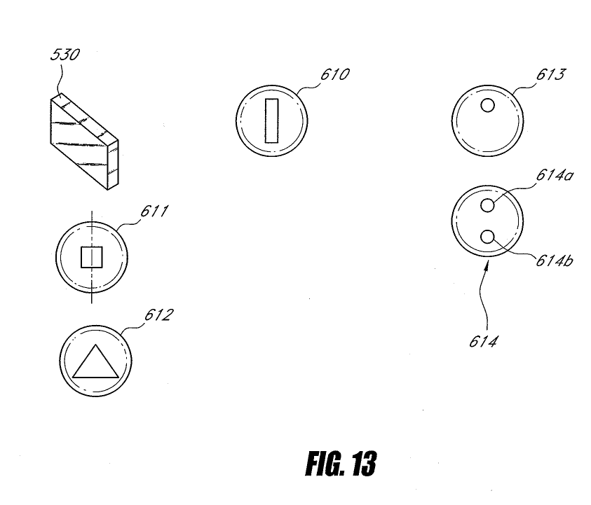

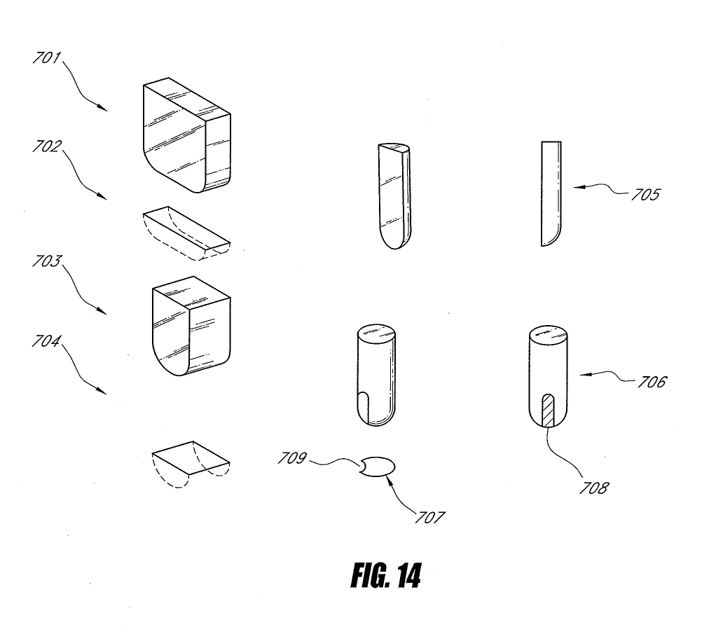

In some embodiments, the first protrusion 30 is a rectangular protrusion that extends from the retaining member 40. In some embodiments, the first protrusion has two or more subprotrusions (e.g., as depicted in FIGS. 12A-12C, a first subprotusion 331 and a second subprotrusion 332). As shown, the presence of two or more subprotrusions can allow for a specific orientation of engagement to be maintained. In some embodiments, the first protrusion 330 (FIG. 12C) includes 2, 3, 4, 5, 6, 7, 8, 9, 10, or more parts or “subprotrusions” (332 and 331). In some embodiments, the subprotrusions are paired with one or more first indentations 311, which can also involve subparts (also denoted as a first subindentation 520 and a second subindentation 521). FIGS. 12A and 12B depict an embodiment of a first seat 510 with the first indentation 311 that has two subindenatations 521 and 520, which are configured to receive the first protrusion 330 that has two subprotrusions 332 and 331 (depicted in FIG. 12C). In some embodiments, the second protrusion 350 can be similar to that used in other embodiments. In some embodiments, subprotrusions can also be employed in the second protrusion 350 (and of course the corresponding second indentations can also include subindentations). In some embodiments, the pivot member also includes a retaining member 340. In some embodiments, the first subprotrusion 331 can be longer than the second subprotrusion 332, such that the subprotrusion 331 can remain engaged in the subindentation 520, while the subprotrusion 332 can disengage and pivot from the subprotrusion 521. In some embodiments, the longer subprotrusion 331 can function as an axle for pivoting. In some embodiments, the longer such subprotrusion can remain engaged throughout the pivoting process. In some embodiments, the first protrusion is made of, for example, plastic, nylon, rubber, metal, copper, brass, iron, steel bronze, nickel, wood, or any combination thereof. In some embodiments, the first protrusion 30 includes one or more corners 31, 32. In some embodiments, the corners 31, 32 are approximately ninety degrees. In some embodiments the corners 31, 32 are configured to meet securely with the first indentation 120 of the first seat 110, so that a force along direction 150, when the first protrusion 30 is in the first indentation 120, will not result in the removal of the first protrusion from the first indentation. In some embodiments, the corners 31, 32 have an angle of about 95 degrees or smaller, for example, 94, 90, 85, 80, 75, 70, 65, 60, 50, 40, 30, or 10 degrees, such that the first protrusion is less likely to be removed from the first indentation 120 when a force is applied perpendicularly (direction 150). However, such angles need not interfere with the first protrusion entering the retracted position 140 or the extended position 130. In some embodiments, the shape of the first indentation 120 complements the corresponding angle of the corner of the first protrusion, so as to make it further unlikely that the first protrusion will become unintentionally unseated. In some embodiments, the first protrusion is optional. In some embodiments, the shape of the first indentation and the first protrusion can vary. In some embodiments, the first indentation is rectangular (see, e.g., FIG. 13 530) and can be matched with the correspondingly shaped first indentation 610 to allow the first protrusion 530 to sit in the first indentation 610. In some embodiments, the first indentation is a square 611. In some embodiments, the first indentation is a triangle 612. In some embodiments, the first indentation is an offset circle 613. In some embodiments, the first indentation 614 includes two circular subindentations 614a and 614b. While not depicted, the corresponding first protrusions that can couple with the shown first indentations are also contemplated herein and adequately described by the noted indentation structures, as the first protrusions can have a shape configured to interact or couple with the first indentations displayed. In some embodiments, any shape can be used as long as it is capable of being aligned at rest and then becoming unaligned when the pivot member starts to pivot.

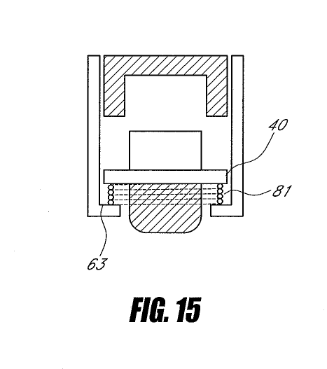

In some embodiments, the second protrusion 50 is a rectangular protrusion that extends from the retaining member 40. In some embodiments, the second protrusion shape can serve one or more of three purposes (1) when no forces are applied, the protrusion can sit securely in the second seat, (2) when an opening or closing force is applied, the shape of the edges of the protrusion 50 can be configured to allow the protrusion to slide in or out of the second seat, and/or (3) when the apparatus is acting as a hinge, rotation of the door can also rotate the pivot member. In some embodiments, the shape can be any shape as long as at least one, two, or three of these still apply. In some embodiments, at least one flat edge can allow aspect (3). In some embodiments, a cylindrical protrusion with rounded corners would satisfy (1) and (2) but not (3). FIG. 14 depicts various embodiments for the second protrusion and the second indentation. In some embodiments, the second protrusion is rectangular 701 and the second indentation is rectangular 702. In some embodiments, the second protrusion is square 703 and the second indentation is square 704. In some embodiments, the second protrusion is circular 705 and the second indentation is also circular (not shown). In some embodiments, the second protrusion is circular 706 with a notch 708 and the second indentation is circular 707 with a corresponding shape to match the notch 709. In some embodiments, the end of the protrusion is curved or rounded. In some embodiments, the second protrusion is made of, for example, plastic, nylon, rubber, metal, copper, brass, iron, steel, bronze, nickel, wood, or any combination thereof. In some embodiments, the second protrusion 50 includes one or more corners 51, 52. In some embodiments, the corners 51, 52 are curved or rounded, so as to encourage or promote an upward motion of the pivot member when a force is applied in a perpendicular direction 150. In some embodiments the corners 51, 52 are configured to meet with the second indentation 20 of the first seat 10, so that a force along direction 150, when the second protrusion 50 is in the second indentation 20, will result in the removal of the second protrusion from the second indentation. In some embodiments, the corners 51, 52 have an angle of about 85 degrees or greater, for example, 86, 90, 95, 100, 105, 110, 115, 120, 130, 140, 150, 160, or 170 degrees, such that the second protrusion is more likely to be removed from the second indentation when a perpendicular force (direction 150) is applied. However, such angles need not interfere with the second protrusion entering the retracted position 140 or the extended position 130. In some embodiments, the shape of the second indentation 20 complements the corresponding angle of the corners of the first protrusion, so as to further encourage the second protrusion becoming unseated when a perpendicular force is applied in direction 150.

In some embodiments, more than one first and/or more than one second protrusions are employed (e.g., FIG. 12A-12C).

In some embodiments, the first and/or second protrusions extend substantially perpendicularly from a surface of the retaining member 40. In some embodiments, one or both protrusions are adequately perpendicular so as to allow the protrusion to engage a indentation of a seat with the required force (for pivoting) while also allowing the pivot member 1 to move to and between the retracted 140 (or elevated) and extended 130 (or lowered) positions. In some embodiments, the first protrusion 30 is on the top of the retaining member 40 and the second protrusion 50 is on the bottom of the retaining member 40. In some embodiments, the first and/or second protrusion is not perpendicular to a surface to the retaining member 40.

In some embodiments the first seat 110 is circular, as shown in FIG. 5. In some embodiments, the top surface of the first seat 110 is square. In some embodiments, the first seat 110 is removable from the housing 60. In some embodiments, the first seat 110 includes threads 164 that can engage with threads 64 in the housing. In some embodiments, the first seat 110 is detachable from the housing 60. In some embodiments, the first seat 110 is within the housing 60. In some embodiments, the first seat 110 includes an indentation 120. In some embodiments, the indentation is shaped to be complementary to the first protrusion. In some embodiments, the indentation is rectangular. In some embodiments, the first seat 110 is made of, for example, plastic, nylon, rubber, metal, copper, brass, iron, steel, bronze, nickel, wood (e.g., frame or door), or any combination thereof. In some embodiments, the first seat 110 is made from the wood or material of the door or frame and the indentation is a hole in the door or frame. In such embodiments, only an appropriately shaped and positioned indentation need be present. In some embodiments, the first seat 110 does not pivot with respect to the housing. In some embodiments, the first seat 110 does not pivot with respect to the pivot member 1 when the first protrusion 30 is engaged with the first indentation 120. In some embodiments, the bottom surface of the first seat 121, blocks or obstructs the pivot member 1 from moving from an extended position 130 (as shown in FIG. 9) to a retracted position 140, unless the first projection 30 is aligned with the first indentation 120.

In some embodiments the second seat 10 is circular, as shown in FIG. 7. In some embodiments, the top surface of the second seat is square. In some embodiments, the second seat 10 includes a hole in a top surface so it can be attached to a door or frame by screws or nails. In some embodiments, the second seat 10 includes an indentation 20. In some embodiments, the indentation is shaped to be complementary to the second protrusion 50. In some embodiments, the indentation is sloped, curved, or rounded so as to encourage an upward movement of a second protrusion when opposite forces are applied along direction 150 to the top and the bottom of the hinged-latch 201. In some embodiments, the indentation includes at least one angle that is greater than ninety degrees 21, 22. In some embodiments, the first seat is made of, for example, plastic, nylon, rubber, metal, copper, brass, iron, bronze, nickel, wood (e.g., frame or door), or any combination thereof. In some embodiments, the first seat is made from the wood or material of the door or frame and the indentation is a hole in the door or frame. In such embodiments, only an appropriately shaped and positioned indentation need be present. In some embodiments, the second seat 10 can pivot with respect to the housing 60. In some embodiments, the second seat 10 can pivot with respect to the first seat 110. In some embodiments, the second seat 10 does not pivot with respect to the pivot member 1 when the second protrusion 50 is engaged with the second indentation 20. In some embodiments, the second indentation 20 is configured to receive the second protrusion 50 when the second indentation 20 is aligned with the second protrusion 50, but not when the second protrusion 50 is out of alignment with the second indentation 20.

In some embodiments, the first, second, or first and second indentation is a hole that passes completely through the seat or disk. In some embodiments, the first, second, or first and second indentation does not pass completely through the seat or disk. In some embodiments, the first, second, or first and second indentation is a hole in a door or a frame.

In some embodiments the spring 80 urges the pivot member 1 away from the first seat 110. In some embodiments the spring 80 is positioned between the first seat 110 and the pivot member. In some embodiments, the spring 80 is positioned between the first seat 110 and the retaining member 40. In some embodiments, the spring 80 is positioned between the retaining member 40 and the housing. In some embodiments, the spring 80 is positioned between the first seat 110 and the inner lip 63. In some embodiments the spring 80 exerts sufficient force to allow a door to pivot without disengaging the second protrusion from the second seat, when the door is fully opened. In some embodiments, the spring 80 exerts sufficient force to allow the door to pivot, without disengaging the second protrusion 50 from the second seat 10, when the door is fully opened, and to support the weight of the door as well. In some embodiments, the spring is a coiled spring. In some embodiments, the spring is a leaf spring. In some embodiments, there can be a spring on a surface of the retaining member 40 and the inner lip 63 that applies a spring force as it is expanded. In some embodiments, the spring is a tension spring 81, as shown in FIG. 15. Thus, in some embodiments, the biasing of the pivot member can be a pulling force, rather than a separating force. In some embodiments, a magnet or pair of magnets is employed in place of a physical spring. In some embodiments a compressible member is employed. In some embodiments, the compressible member is a gel or flexible foam.

In some embodiments, the hinged-latch is simple to manufacture and install and can include relatively few moving parts. In some embodiments, the hinged-latch contains a safety mechanism that disables the opposite hinged-latch once the door has started opening from the other side. In some embodiments this hinged-latch allows a door to open either left- or right-handed, thus allowing more freedom in home design.

In some embodiments, the hinged-latch 201 can be placed on the corners of doors (e.g., as shown in FIG. 10). In some embodiments, a first pair of hinged-latches 201a and 201b are positioned on a first side of a door 400, to one side of the center 300 of the door. A second pair of hinged-latches 201c and 201d can be positioned in a second side of the door 400, to the other side of the center 300 of the door. In some embodiments, the pairs of hinged-latches (as well as the pivot lines) can be positioned anywhere within in the first half of the door 220, for the first pair of hinged-latches 201a and 201b, and the handle 410 can be positioned anywhere within a section 411 on the door. In some embodiments, the pairs of hinged-latches (as well as the pivot lines) can be positioned anywhere within in the second half of the door 210, for the second pair of hinged-latches 201c and 201d, and the handle 420 can be positioned anywhere within a section 421 on the door. As will be appreciated by those of skill in the art, in light of the present disclosure, positioning the handles 420, and 410 distal to the center, and/or positioning the hinged-latches 201a, 201b, 201c, and 201d distal to the center 300 will allow for greater easy of opening the door in either or both of the directions. As will be appreciated by those of skill in the art, in light of the present disclosure, positioning the pairs of hinged-latches closer to the center will move the corresponding pivot line closer to the center of the door. In some embodiments, an apparatus is provided that includes a frame, a door configured to fit within the frame, and a set of hinged-latches, pivotably associating the door to the frame. In some embodiments, one or more of the hinged-latches includes any of the hinged-latches described herein, such as one including a pivot member having a first protrusion, a retaining member coupled to the first protrusion, and a second protrusion coupled to the retaining member. In some embodiments, the hinged-latch can also include a first seat that includes a first indentation, where the first indentation is configured to receive the first protrusion when the first protrusion and the first indentation are aligned, but not when the first protrusion and the first indentation are not aligned. The hinged-latch can also include a housing including a proximal opening through which the second protrusion can extend. The housing can be configured to retain the retaining member while allowing movement of the pivot member from an extended position, in which the pivot member is capable of pivoting, to a retracted position. The first seat can be positioned so that a surface of the first seat blocks the pivot member from moving from the extended position to the retracted position unless the first projection is aligned with the first indentation. The hinged latch can also include a second seat having a second indentation, wherein the second indentation is configured to receive the second protrusion, wherein when the second indentation receives the second protrusion, the second indentation and second protrusion are unable to rotate with respect to one another. In some embodiments, the door is associated with the frame by two hinged-latches. In some embodiments, the door is associated with the frame by a first hinged-latch, a second hinged-latch, a third hinged-latch, and a fourth hinged-latch. In some embodiments, the door includes a topside and a bottom side. The first hinged-latch attaches the door to the frame at the topside of the door. The second hinged-latch attaches the door to the frame at the bottom side of the door. The third hinged-latch attaches the door to the frame at the topside of the door. The fourth hinged-latch attaches the door to the frame at the bottom side of the door.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

1. An apparatus comprising:
a pivot member comprising:
a first protrusion;
a retaining member coupled to the first protrusion; and
a second protrusion coupled to the retaining member;
a first seat comprising a first indentation, wherein the first indentation is configured to receive the first protrusion when the first protrusion and the first indentation are aligned, but not when the first protrusion and the first indentation are not aligned;
a housing comprising a proximal opening through which the second protrusion can extend, wherein the housing is configured to retain the retaining member while allowing movement of the pivot member from an extended position, in which the pivot member is capable of pivoting, to a retracted position, wherein the first seat is positioned so that a surface of the first seat blocks the pivot member from moving from the extended position to the retracted position unless the first projection is aligned with the first indentation; and
a second seat comprising a second indentation, wherein the second indentation is configured to receive the second protrusion, wherein when the second indentation receives the second protrusion, the second indentation and second protrusion are unable to rotate with respect to one another.

2. The apparatus of claim 1, wherein the first protrusion and the retaining member are located within the housing.

3. The apparatus of claim 1, wherein the retaining member comprises a plate having a first surface and an oppositely situated second surface, wherein the first protrusion extends substantially perpendicularly from the first surface, and wherein the second protrusion extends substantially perpendicularly from the second surface.

4. The apparatus of claim 3, wherein the plate is a disk, and wherein a diameter of the disk is too large to pass completely through the proximal opening of the housing.

5. The apparatus of claim 1, wherein the housing comprises a hole in a frame or a door, and wherein the first seat is positioned within the hole.

6. The apparatus of claim 1, wherein the housing comprises a cylinder.

7. The apparatus of claim 1, wherein the housing comprises a proximal end, comprising the proximal opening, and a distal end, comprising the first seat.

8. The apparatus of claim 7, wherein the first seat is removably attached to the distal end of the housing.

9. The apparatus of claim 1, further comprising a spring, wherein the spring is positioned within the housing and urges the first protrusion away from the first seat.

10. The apparatus of claim 9, wherein the spring exerts a spring force between the first seat and the retaining member.

11. The apparatus of claim 1, wherein the pivot member comprises plastic, metal, brass, copper, aluminum, or steel.

12. The apparatus of claim 1, wherein the first, second, or first and second protrusion comprises plastic, metal, brass, copper, aluminum, or steel.

13. The apparatus of claim 1, wherein the first protrusion is rectangular.

14. The apparatus of claim 1, wherein the second protrusion is rectangular.

15. The apparatus of claim 1, wherein a first corner, a second corner, or the first and the second corner of the second protrusion is configured to promote the second protrusion out of the second indentation when a separating force is exerted between the second protrusion and the second seat.

16. The apparatus of claim 1, wherein a first corner, a second corner, or the first and the second corner of the second protrusion is rounded.

17. The apparatus of claim 1, wherein a first corner of the first protrusion comprises a right angle and wherein a second corner of the first protrusion comprises a right angle.

18. The apparatus of claim 1, wherein the pivot member is magnetically biased towards the proximal end of the housing.

19. The apparatus of claim 1, wherein the second indentation is configured to receive the second protrusion when the second indentation is aligned with the second protrusion, but not when the second protrusion is out of alignment with the second indentation.

20. The apparatus of claim 1, wherein the second seat comprises a disk, and wherein the second indentation extends perpendicularly into a first surface of the disk of the second seat.

21. The apparatus of claim 1, wherein the second indentation is a hole that passes completely through the disk.

22. The apparatus of claim 1, wherein the second indentation does not pass completely through the disk.

23. The apparatus of claim 1, wherein the first, second, or first and second indentation is an indentation in a frame or door.

24. A pivotable structure comprising:
a pivot member comprising:
a first rectangular protrusion having a first corner and a second corner;
a retaining member comprising a first surface and an oppositely positioned second surface, wherein the first protrusion is attached to and extends substantially perpendicularly outward from the first surface;
a second protrusion having a third corner and a fourth corner, wherein the second protrusion is attached to and extends substantially perpendicularly outward from the second surface, wherein the third corner comprises an angle that is greater than ninety degrees, and wherein the fourth corner comprises an angle that is greater than ninety degrees;
a seat comprising an indentation, wherein the indentation is configured to receive the first rectangular protrusion when the first rectangular protrusion is aligned such that a surface of the first rectangular protrusion is substantially parallel with a surface of a wall of the indentation; and
a housing comprising:
a spring; and
a proximal opening that is too small to allow the retaining member to fit through, wherein the pivot member is positioned such that the second protrusion extends through the proximal opening of the housing while the first protrusion remains within the housing, and wherein the housing allows movement of the retaining member to a first position close to the proximal opening, in which the pivot member is capable of pivoting, to a second position that is more distal to the proximal opening, and
wherein the spring is positioned to urge the retaining member to the first position.

25. An apparatus comprising:
a frame;
a door configured to fit within the frame; and
a set of hinged-latches, pivotably associating the door to the frame, wherein each hinged-latch comprises:
a pivot member comprising:
a first protrusion;
a retaining member coupled to the first protrusion; and
a second protrusion coupled to the retaining member;
a first seat comprising a first indentation, wherein the first indentation is configured to receive the first protrusion when the first protrusion and the first indentation are aligned, but not when the first protrusion and the first indentation are not aligned;
a housing comprising a proximal opening through which the second protrusion can extend, wherein the housing is configured to retain the retaining member while allowing movement of the pivot member from an extended position, in which the pivot member is capable of pivoting, to a retracted position, wherein the first seat is positioned so that a surface of the first seat blocks the pivot member from moving from the extended position to the retracted position unless the first projection is aligned with the first indentation; and
a second seat comprising a second indentation, wherein the second indentation is configured to receive the second protrusion, wherein when the second indentation receives the second protrusion, the second indentation and second protrusion are unable to rotate with respect to one another.

26. The apparatus of claim 25, wherein the door is associated with the frame by two hinged-latches.

27. The apparatus of claim 25, wherein the door is associated with the frame by a first hinged-latch, a second hinged-latch, a third hinged-latch, and a fourth hinged-latch.

28. The apparatus of claim 27, wherein the door comprises a topside and a bottom side, wherein the first hinged-latch attaches the door to the frame at the topside of the door, wherein the second hinged-latch attaches the door to the frame at the bottom side of the door, wherein the third hinged-latch attaches the door to the frame at the topside of the door, and wherein the fourth hinged-latch attaches the door to the frame at the bottom side of the door.

29. A method of operating a dual pivot point door comprising:
providing a dual pivot point door comprising:
a frame;
a door configured to fit within the frame; and
a set of hinged-latches, pivotably associating the door to the frame,
wherein each hinged-latch comprises:
a pivot member comprising:
a first protrusion;
a retaining member coupled to the first protrusion; and
a second protrusion coupled to the retaining member;
a first seat comprising a first indentation, wherein the first indentation is configured to receive the first protrusion when the first protrusion and the first indentation are aligned, but not when the first protrusion and the first indentation are not aligned;
a housing comprising a proximal opening through which the second protrusion can extend, wherein the housing is configured to retain the retaining member while allowing movement of the pivot member from an extended position, in which the pivot member is capable of pivoting, to a retracted position, wherein the first seat is positioned so that a surface of the first seat blocks the pivot member from moving from the extended position to the retracted position unless the first projection is aligned with the first indentation; and
a second seat comprising a second indentation, wherein the second indentation is configured to receive the second protrusion, wherein when the second indentation receives the second protrusion, the second indentation and second protrusion are unable to rotate with respect to one another,
wherein the door comprises:
a front surface;
a first pivot line extending from the first hinged-latch though the door to the second hinged-latch; and
a second pivot line extending from the third hinged-latch though the door to the fourth hinged-latch; and
applying a first opening force perpendicularly to the front surface of the door at a position closer to the first pivot line than the second pivot line, such that the first and second hinged-latches operate as latches, and such that the third and fourth hinged-latches operate as hinges and the door pivots about the second pivot line.

30. The method of claim 29, further comprising:
applying a force opposite in direction to the first opening force, thereby closing the door; and
applying a second opening force perpendicularly to the front surface of the door at a position closer to the second pivot line than the first pivot line, such that the first and second hinged-latches operate as hinges, and such that the third and fourth hinged-latches operate as latches so that the door pivots about the first pivot line.
